(19) United States
(12) Patent Application Publication
(10) Pub. No.: US 2003/0123910 A1
(43) Pub. Date: Jul. 3, 2003

(54) Image forming system in electrophotographic printer having an image charging unit and method for forming image using the same

(75) Inventors: Wan-Ha Kim, Suwon-si (KR); Kwang-Ho No, Suwon-si (KR); Jong-Woo Kim, Suwon-si (KR); Woo-Young Park, Suwon-si (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/133,476

(22) Filed: Apr. 29, 2002

(30) Foreign Application Priority Data
Dec. 28, 2001 (KR) 2001-86888

(51) Int. Cl. G03G 15/16

(52) U.S. Cl. 399/296

(57) ABSTRACT

An image forming system in an electrophotographic printer and a method for forming an image using the system. The image forming system includes a photosensitive medium on which an electrostatic latent image is formed, a developing unit for developing the electrostatic latent image with developing solution having a predetermined color, a transfer medium onto which the developed image is transferred, an image charging unit for charging the image transferred onto the transfer medium, and a transferring unit for transferring the charged image onto a paper. In the above configuration, an electric force required for the transferring step is enhanced by the image charging unit before the image on the transfer medium is transferred onto the paper, and thereby the efficiency of transferring the image onto the paper is improved more.

### BACKGROUND OF THE INVENTION

1. Field of the Invention

The present invention relates to an image forming system in an electrophotographic printer and a method for forming an image using the system. The present application is based on Korean Application No. 2001-0086888, filed Dec. 28, 2001, which is incorporated herein by reference.

2. Description of the Related Art

In general, an image forming system in an electrophotographic printer such as a color laser printer, as shown in FIG. 1, includes four photosensitive drums Dy, Dm, Dc, and Dk, which are prepared to correspond to four colors such as yellow, magenta, cyan, and black, a charger 11 for charging the four photosensitive drums Dy, Dm, Dc, and Dk, an exposure unit 12 for scanning light on each of the charged photosensitive drums Dy, Dm, Dc, and Dk and forming an electrostatic latent image of a desired image, a developing unit 13 for developing the electrostatic latent image with developing solution for each of the four colors, a transfer belt 14 onto which the image developed on each of the photosensitive drums Dy, Dm, Dc, and Dk sequentially overlapped is transferred, for forming a finished color image, and a transferring unit 16 for transferring the image of the transfer belt 14 onto a paper P. Thus, in order to print a desired color image, an image for each color is developed on the four photosensitive drums Dy, Dm, Dc, and Dk, and the image is stamped so that the images overlap the same image position on the transfer belt 14, and a final color image is formed, and then, the final color image is printed onto the paper P through the transferring unit 16.

Here, the transferring unit 16 includes a paper transfer roller 16a and a paper transfer backup roller for closely adhering the paper P to the transfer belt 14, and an electric potential-applying portion 16c for applying an electric force so that the image formed on the transfer belt 14 is well transferred onto the paper P by applying a voltage to the paper transfer backup roller 16b. This illustrates a case where a toner as a main component of a developing solution used in forming an image is charged to plus (+), and the electric potential-applying portion 16c also applies a positive (+) voltage to the paper transfer backup roller 16b so that the image is well transferred onto the paper P by an electric repulsive force. That is, in a case where the image developed on the photosensitive drums Dy, Dm, Dc, and Dk is transferred onto the transfer belt 14, negative (−) voltages are applied to backup rollers 15 of the corresponding photosensitive drums Dy, Dm, Dc, and Dk so that the image of the toner charged to plus (+) by an electric attractive force is well transferred onto the transfer belt 14. In a case where the image of the toner is transferred onto the paper P, a positive (+) voltage is applied to the paper transfer backup roller 16b so that the image of the toner is well transferred onto the paper P from the transfer belt 14 by the electric repulsive force.

It is preferable that the whole image formed on the transfer belt 14 is transferred onto the paper P. However, in the above structure, since a transferring step is performed only by the electric repulsive force caused by the positive (+) voltage applied to the paper transfer backup roller 16b, a considerable amount of the developing solution which is not transferred onto the transfer belt 14 remains even after the transferring step. Even though there is of course pressure under which the paper transfer roller 16a and the paper transfer backup roller 16b closely adhere the paper P to the transfer belt 14, the typical force of less than 3 kgf does not cause the paper transfer roller 16a and the paper transfer backup roller 16b to adhere the paper P to the transfer belt 14 very closely. Meanwhile, a method for increasing pressure applied to the paper P and applying heat to the paper transfer roller 16a has been suggested so as to increase the efficiency of transfer. However, in this case, even though the efficiency of transfer is slightly increased, the toner remaining on the transfer belt 14 is strongly adhered such that its cleaning is not well performed compared to the prior art, and the lifetime of the transfer belt 14 is thereby reduced. However, in a case where the amount of the toner of the image formed on the transfer belt 14 is reduced by decreasing the concentration of the developing solution, the concentration of the image is decreased, but this results in lowered print quality.

Thus, an image forming system in which the pressure applied to the paper during a transferring step is not increased, and the efficiency of transfer is improved, is required.

### SUMMARY OF THE INVENTION

To solve the above problems, it is an object of the present invention to provide an image forming system in an electrophotographic printer having an improved structure in which pressure applied to a paper with respect to a transfer medium during a transferring step is not increased, and the efficiency of transfer is improved, and a method for forming an image using the system.

Accordingly, to achieve the above object, according to one aspect of the present invention, there is provided an image forming system in an electrophotographic printer. The system includes a photosensitive medium on which an electrostatic latent image is formed, a developing unit for developing the electrostatic latent image with developing solution having a predetermined color, a transfer medium onto which the developed image is transferred, an image charging unit for charging the image transferred onto the transfer medium, and a transferring unit for transferring the charged image onto a paper.

To achieve the above object, according to another aspect of the present invention, there is provided a method for forming an image in an electrophotographic printer. The method includes the steps of developing an electrostatic latent image formed on a photosensitive medium with developing solution having a predetermined color, firstly transferring the developed image onto a transfer medium, image-charging the developed image, and secondly transferring the charged image onto a paper.

### BRIEF DESCRIPTION OF THE DRAWINGS

The above object and advantages of the present invention will become more apparent by describing in detail a preferred embodiment thereof with reference to the attached drawings in which:

FIG. 1 illustrates an image forming system of a conventional electrophotographic printer; and

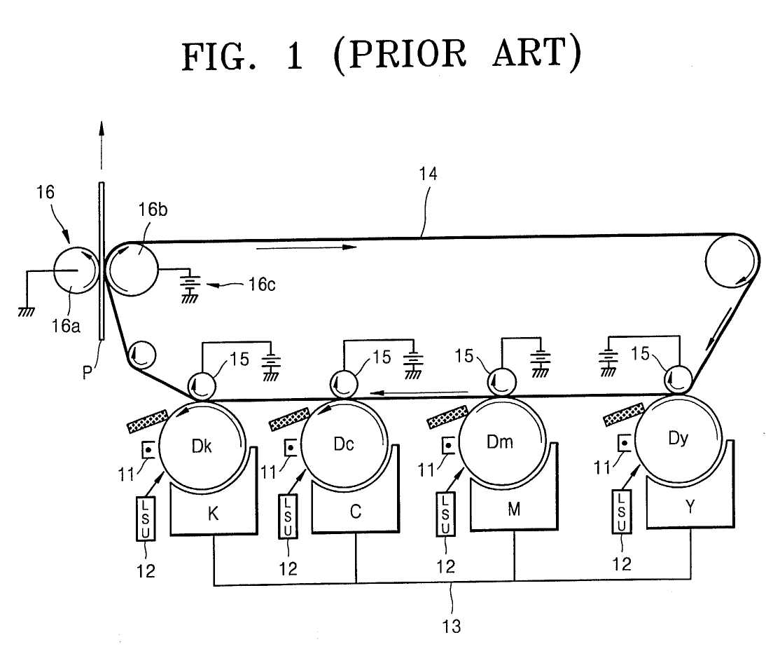

FIG. 2 illustrates an image forming system of an electrophotographic printer according to the present invention.

### DETAILED DESCRIPTION OF THE INVENTION

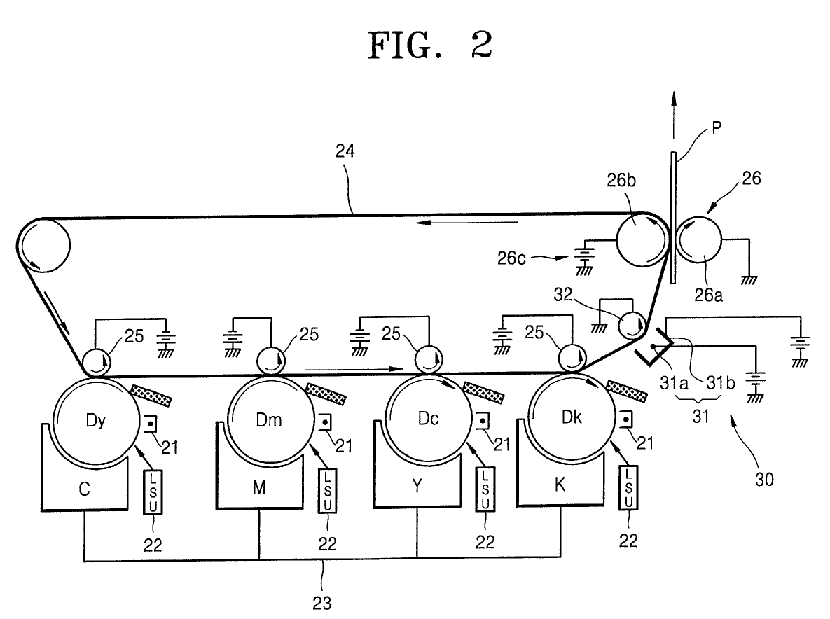

FIG. 2 illustrates an image forming system of an electrophotographic printer according to the present invention. As shown in FIG. 2, the image forming system in an electrophotographic printer according to the present invention includes photosensitive drums Dc, Dm, Dy, and Dk as photosensitive media, a charger 21 for charging the photosensitive drums Dc, Dm, Dy, and Dk, a laser scanning unit (LSU) 22 as an exposure unit, for scanning light on each of the charged photosensitive drums Dc, Dm, Dy, and Dk and forming an electrostatic latent image of a desired image, a developing unit 23 for developing the electrostatic latent image, a transfer belt 24 as a transfer medium, onto which the developed image is firstly transferred, and a transferring unit 26 for secondly transferring the image transferred onto the transfer belt 24 onto a paper P.

An image forming system for realizing a color image is illustrated in the present embodiment. For this purpose, developers having four colors such as cyan (C), magenta (M), yellow (Y), and black (K), are included in the developing unit 23. Thus, an image corresponding to the above four colors is developed on each of the photosensitive drums Dc, Dm, Dy, and Dk of each of the developers, and then is overlapped and transferred onto the transfer belt 24, and thereby a color image is formed. Reference numeral 25 denotes backup rollers of each of the developers, and negative (−) voltages are applied to the backup rollers 25 as shown in the drawing. The toner particles, as a main component of developing solution, are positively (+) charged, and thus, electric bias is applied so that the image of the toner is well transferred onto the transfer belt 24. Of course, in a case where the toner particles are negatively (−) charged, positive (+) voltages are applied to the backup rollers 25.

A paper transfer roller 26a and a paper transfer backup roller 26b, which are closely adhered to each other between the interposed transfer belt 24 are installed to rotate, and an electric potential-applying portion 26c for applying electric potential to the paper transfer backup roller 26b is included in the transferring unit 26. The electric potential-applying portion 26c applies a positive (+) voltage, which is the same polarity as the developing solution, to the paper transfer backup roller 26b, so that the positively (+) charged image is well transferred onto the paper P. That is, in step of firstly transferring the image onto the transfer belt 24, a transfer step is induced by the electric attractive force caused by the negative (−) voltages, and in step of secondly transferring the image onto the paper P, a transfer step is induced by the electric repulsive force caused by the positive (+) voltage applied to the paper transfer backup roller 26b.

Meanwhile, an image charging unit 30 is installed between the transferring unit 26 and the developing unit 23. The image charging unit 30 increases the electric potential of the image firstly transferred onto the transfer belt 24 before being transferred onto the paper P and includes a corona discharger 31 comprising a tungsten wire 31a for discharge, which is discharged to a positive (+) voltage as the same charge polarity as the developing solution, and a grid 31b for focusing so that a discharge direction is not radiated, and a corona backup roller 32 for supporting the transfer belt 24 in a position opposite to the corona discharger 31. This is the reason the electric potential of the image to be transferred onto the paper P is previously increased, and thereby the stronger electric repulsive force acts in the transferring unit 26, and the image is more smoothly transferred onto the paper P.

In the above configuration, when an image forming process is carried out, the image developed on the photosensitive drums Dc, Dm, Dy, and Dk in each of the developers of the developing unit 23 is firstly transferred onto the transfer belt 24 and overlapped while undergoing charging, exposing, and developing steps. In such a case, the negative (−) voltages are applied to the backup rollers 25, and the image developed with the developing solution positively (+)charged is easily transferred onto the transfer belt 24.

Likewise, a color image is finished on the transfer belt 24 by the step of firstly transferring the image developed on the photosensitive drums Dc, Dm, Dy, and Dk onto the transfer belt 24, and then, the electric potential of the image is increased by the image charging unit 30. That is, when the image passes between the corona discharger 31 and the corona backup roller 32, the corona discharger 31 is discharged, and thereby the electric potential of the image having positive (+) charge is increased more. For this purpose, the positive (+) voltage is applied to the tungsten wire 31a for discharge and also to the grid 31b, and thereby the discharged charge is not radiated but focused toward the image. As a result, the image formed on the transfer belt 24 has a higher electric potential.

The image, having increased electric potential, is secondly transferred onto the paper P from the transferring unit 26. In other words, the electric potential-applying portion 26c applies the positive (+) voltage to the paper transfer backup roller 26b, and thereby an electric repulsive force is applied to the image having positive (+) charge so that the image is transferred onto the paper P. In such a case, the electric potential of the image is further increased by the image charging unit 30, and thus, the electric repulsive force for a second transferring step acts on the image considerably stronger than in the prior art. Thus, the step of transferring onto the paper P from the transfer belt 24 is easily performed, and little of the image remains on the transfer belt 24 after the transferring step.

In an experiment, in which voltage was applied to the tungsten wire 31a for discharge so that only about 200-300 μA of current flows into the tungsten wire 31a for discharge, it was identified that there was little of the image remaining on the transfer belt 24 after the second transferring step, even through pressure applied to the paper P from the transferring unit 26 was not specially increased.

The above description explains the main reason the electric potential of the image is increased just before the transferring step, and thus an electric force required for the transferring step is enhanced, and also the reason a difference in electric potential among colors is reduced in a color image. That is, in the case of the color image, as above, the image for each color developed by the four developers is overlapped on the transfer belt 24, and thereby a minor difference in electric potential for each color occurs. Thus, a color whose electric potential is high is likely to be well transferred onto the paper P, and a color whose electric potential is low is likely to be not well transferred onto the paper P. In this way, in a case where the electric potential of the entire image is increased just before the second transferring step, the electric potential is increased, and simultaneously, a difference in electric potential for each color is reduced.

As a result, a phenomenon that only a part of color is not well transferred by a difference in electric potential for each color, is also reduced, and thus the possibility that the image remains on the transfer belt 24 after the transferring step, is further reduced.

Thus, in this manner, the image transferred onto the transfer belt 24 is charged by the image charging unit 30 just before being transferred onto the paper P, and thereby the electric potential of the image is increased, and the efficiency of transfer is improved.

As described above, the image forming system in an electrophotographic printer according to the present invention has the following effects.

First, the electric potential of the image on the transfer belt is increased just before being transferred onto the paper, and thereby the electric force required for the transferring step is enhanced, and thus, the image is smoothly transferred onto the paper from the transfer belt, and the efficiency of transfer is improved.

Second, since the difference in electric potential for each color is reduced by the above increase in the electric potential of the image, a deviation where the efficiency of transfer is varied according to color, can be reduced.

Third, since the electric force required for the transferring step in the transferring unit is increased over that of the prior art, the voltage applied to the paper transfer backup roller can be reduced so as to reduce the available amount of current available.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. Am image forming system in an electrophotographic printer, the system comprising:
a photosensitive medium on which an electrostatic latent image is formed;
a developing unit for developing the electrostatic latent image with developing solution having a predetermined color;
a transfer medium onto which the developed image is transferred;
an image charging unit for charging the image transferred onto the transfer medium; and
a transferring unit for transferring the charged image onto a printing medium.

2. The system of claim 1, wherein the image charging unit includes a corona discharger comprising a wire for discharge, discharged to the same polarity as a charge of the developing solution, grid for focusing so that a discharge direction is not radiated, and a corona backup roller for supporting the transfer medium in a position opposite to the corona discharger.

3. The system of claim 1, wherein the transferring unit includes a printing medium transfer roller and a printing medium transfer backup roller, which are closely disposed to each other, between which the transfer medium is interposed, and the printing medium transfer roller and the printing medium transfer backup roller rotate, and an electric potential-applying portion for applying an electric force so that the image on a transfer belt is well transferred onto the printing medium passing between the printing medium transfer roller and the transfer belt by applying a voltage having the same polarity as that of the developing solution to the printing medium transfer backup roller.

4. The system of claim 1, wherein the printing medium is paper.

5. A method for forming an image in an electrophotographic printer, the method comprising the steps of:
developing an electrostatic latent image formed on a photosensitive medium with developing solution having a predetermined color;
firstly transferring the developed image onto a transfer medium;
image-charging the developed image; and
secondly transferring the charged image onto a printing medium.
